(19) United States
(12) Patent Application Publication
(10) Pub. No.: US 2025/0217084 A1
(43) Pub. Date: Jul. 3, 2025

(54) STORAGE MEDIUM, PRINT CONTROL METHOD, AND SYSTEM

(71) Applicant: CANON KABUSHIKI KAISHA, Tokyo (JP)

(72) Inventor: Hikaru SUGITA, Ibaraki (JP)

(21) Appl. No.: 18/967,016

(22) Filed: Dec. 3, 2024

(30) Foreign Application Priority Data
Dec. 28, 2023 (JP) 2023-223264

(51) Int. Cl. G06F 3/12

(52) U.S. Cl. CPC G06F 3/1204; G06F 3/1208; G06F 3/1222; G06F 3/1238; G06F 3/1244; G06F 3/1256; G06F 3/126; G06F 3/1288

(57) ABSTRACT

The present invention relates to a computer program for extending a function of a generative AI service. Upon receiving a print request through the generative AI service, the computer program causes a computer of the information processing apparatus to function so as to acquire authentication information related to the user. The computer program causes the above computer to function so as to acquire apparatus information related to an available image forming apparatus from the printing server using the acquired authentication information related to the user, and specify the image forming apparatus to execute printing based on the apparatus information.

### BACKGROUND OF THE INVENTION

### Field of the Invention

The present invention relates to a storage medium storing a computer program for extending functions of an artificial intelligence system, a print control method, and a system.

### Description of the Related Art

An artificial intelligence system, called generative AI, that can generate text, images, or other media in response to a prompt is known. In generative AI such as ChatGPT®, functions can be extended with plug-ins. For example, when text containing a keyword “print” is inputted as an instruction to the generative AI, a plug-in related to printing is selected, and in place of the generative AI, the plug-in performs processing that cannot be handled by the generative AI, thereby allowing functions to be extended.

Meanwhile, in image forming apparatuses, print data can be inputted from a cloud server and printed. For example, Japanese Patent Laid-Open No. 2018-128843 proposes a technique in which a document managed by a cloud server can be printed through a chat conversation.

However, when printing output, such as text that is generated by generative AI, on an image forming apparatus, a user or the like needs to copy it to a file or the like and execute printing from a print driver or the like. That is, the user needs to copy the output generated by the generative AI in order to execute printing, which is cumbersome.

### SUMMARY OF THE INVENTION

The present invention enables realization of a mechanism for suitably printing output from generative AI on an image forming apparatus.

One aspect of the present invention provides a non-transitory computer-readable storage medium storing a computer program for extending a function of a generative AI service, wherein the computer program is for causing a computer of an information processing apparatus to function so as to: upon accepting a print request via the generative AI service, acquire authentication information related to a user; using the acquired authentication information related to the user, acquire apparatus information related to an available image forming apparatus from a printing server; and based on the apparatus information, specify an image forming apparatus to execute printing.

Another aspect of the present invention provides a print control method comprising: upon accepting a print request via a generative AI service provided by an information processing apparatus, acquiring authentication information related to a user; using the acquired authentication information related to the user, acquiring apparatus information related to an available image forming apparatus from a printing server; and based on the apparatus information, specifying an image forming apparatus to execute printing.

Still another aspect of the present invention provides a printing system including an information processing apparatus providing a generative AI service to a user terminal, a printing server, and an image forming apparatus, the information processing apparatus comprising: one or more first memory devices that store a computer program for extending a function of the generative AI service; and one or more first processors that execute the computer program to: upon accepting a print request via the generative AI service, acquire authentication information related to a user; using the acquired authentication information related to the user, acquire apparatus information related to an available image forming apparatus from a printing server; and based on the apparatus information, specify an image forming apparatus to execute printing, and the printing server comprising: one or more second memory devices that store a set of instructions; and one or more second processors that execute the set of instructions to: provide the apparatus information associated with the authentication information related to the user; and upon being instructed to execute printing via the generative AI service, input a print job based on the print request to the specified image forming apparatus.

Further features of the present invention will be apparent from the following description of exemplary embodiments with reference to the attached drawings.

### BRIEF DESCRIPTION OF THE DRAWINGS

FIG. 1 is a diagram illustrating a configuration of a system according to one embodiment.

FIG. 2 is a diagram illustrating a configuration of an MFP according to one embodiment.

FIG. 3 is a diagram illustrating a configuration of a user terminal according to one embodiment.

FIG. 4 is a diagram illustrating a configuration of a generative AI server according to one embodiment.

FIG. 5 is a diagram illustrating a configuration of an extension application server according to one embodiment.

FIG. 6 is a diagram illustrating a configuration of a cloud printing server according to one embodiment.

FIG. 7 is a diagram illustrating an example of a screen indicating interaction with generative AI displayed on a user terminal according to one embodiment.

FIGS. 8A-8C are a sequence diagram of document printing according to one embodiment.

FIG. 9 is a diagram illustrating an example of a screen for changing a setting through interaction with generative AI displayed on a user terminal according to one embodiment.

FIGS. 10A-10B are a flowchart related to the extension application server according to one embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### System Configuration

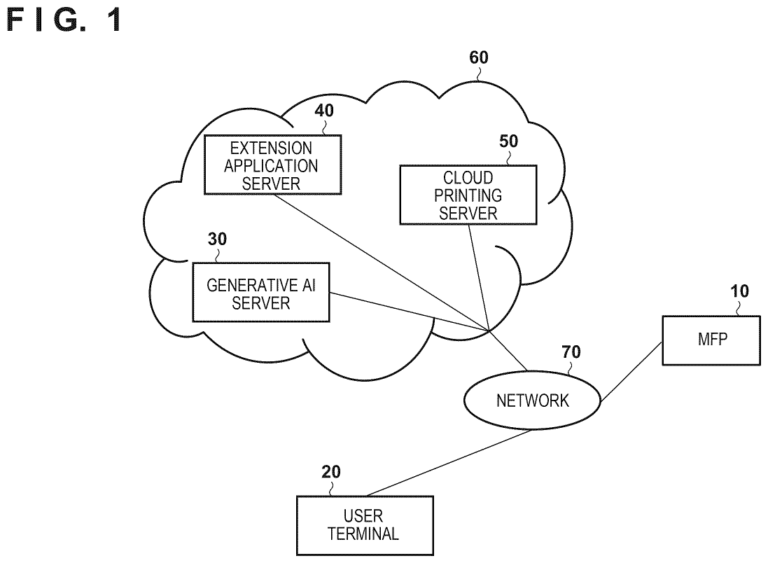

A first embodiment of the present invention will be described below. In the present embodiment, description will be given using a multi function peripheral (MFP) that includes printing, scanning, and FAX functions as an example of an image processing apparatus. FIG. 1 illustrates an example of a diagram of an overall configuration of a printing system that provides a printing service through a generative AI service according to the present invention. The printing system is configured to include an MFP 10 (e.g., printing apparatus), a user terminal 20, a generative AI server 30, an extension application server 40, and a cloud printing server 50. They are connected so as to be capable of communicating with each other via a network 70. The network 70 is a wireless or wired network constituted by a WAN or a LAN.

The MFP 10 indicates a printing apparatus that includes a function of printing an image notified from the cloud printing server 50. The user terminal 20 indicates an information terminal such as a smartphone, a tablet terminal, or a personal computer for when a user uses a generative AI service such as ChatGPT. The user accesses the generative AI server 30 on the cloud by operating the user terminal 20 and executes a generative AI application. The user terminal 20 and the generative AI server 30 are connected to a wired or wireless communication network, and each is capable of transmitting and receiving data. In the present embodiment, a public line on the Internet is assumed as an example of a communication network, but a dedicated line may be used.

The generative AI server 30 is a cloud server (information processing apparatus) arranged on the cloud 60, which provides generative AI such as ChatGPT, which is text-generating AI. The generative AI server 30 provides services in cooperation with the extension application server 40. The generative AI server 30 interprets a message transmitted from the user terminal 20, generates an appropriate response, and displays the response on a screen of the user terminal 20. In addition, the generative AI server 30 can be extend its functions by communicating with the extension application server 40.

The extension application server 40 is a cloud server (information processing apparatus) arranged on the cloud 60 and includes a function of providing additional functions (plug-ins) to the generative AI server 30. The generative AI server 30 can perform processing that it could not have performed alone by implementing a predetermined plug-in, which is a computer program, in cooperation with the extension application server 40. The cloud printing server 50 is a printing server that, upon receiving a print request from the user terminal 20, notifies the MFP 10 that a print job has been received. The MFP 10 receives the print job from the cloud printing server 50 and executes printing according to the notification from the cloud printing server 50. Here, an example in which various servers are provided individually will be described, but each server may be provided so as to be integrated with another server. For example, the generative AI server 30 and the extension application server 40 may be provided in an integrated manner.

### Hardware Configuration of Image Forming Apparatus

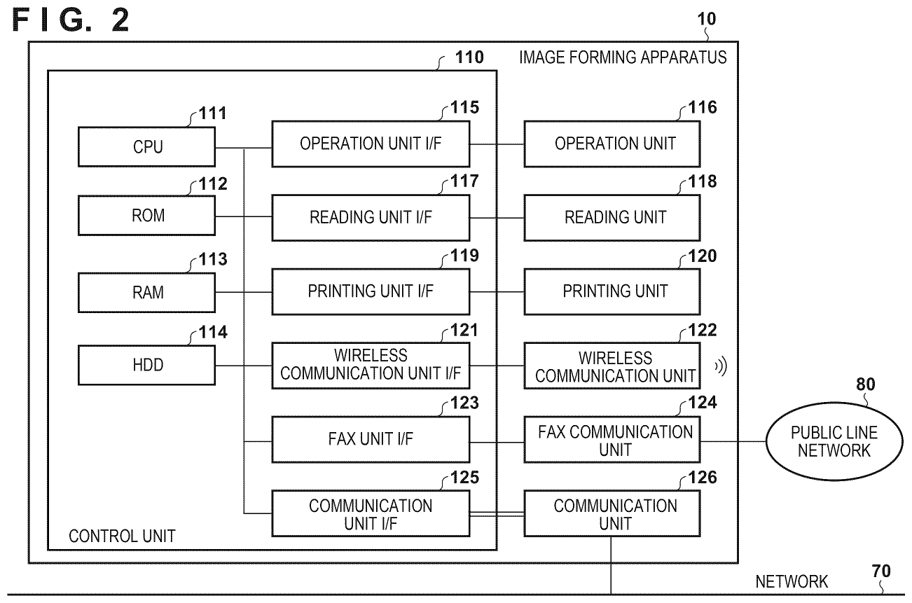

An example of a hardware configuration of the MFP 10 according to the present embodiment will be described with reference to FIG. 2. The MFP 10 includes a control unit 110, an operation unit 116, a reading unit 118, a printing unit 120, a wireless communication unit 122, a FAX communication unit 124, and a communication unit 126. The control unit 110 includes a CPU 111, a ROM 112, a RAM 113, an HDD 114, an operation unit I/F 115, a reading unit I/F 117, a printing unit I/F 119, a wireless communication unit I/F 121, a FAX unit I/F 123, and a communication unit I/F 125.

The control unit 110, which includes the CPU 111, controls the operation of the entire MFP 10. The CPU 111 reads a control program stored in the ROM 112 or the HDD 114 into the RAM 113 and performs various kinds of control such as read control and print control. The ROM 112 stores control programs that can be executed by the CPU 111. The ROM 112 also stores a boot program, font data, and the like. The RAM 113 is a main storage memory and is used as a work area and as a temporary storage area for deploying various control programs stored in the ROM 112 and the HDD 114. The HDD 114 stores image data, print data, various programs, various addresses, and various kinds of setting information. The HDD 114 is a storage medium but need not be an HDD and may be a solid state drive (SSD), an embedded Multi Media Card (eMMC), or the like.

The MFP 10 according to the present embodiment is assumed to be such that one CPU 111 executes each process indicated in the flowcharts to be described later using one memory (RAM 113), but is not limited thereto. For example, a plurality of CPUs, RAMs, ROMs, and HDDs may cooperate to perform each process. Further, a hardware circuit such as an ASIC or an FPGA may be used to execute some processes.

The operation unit I/F 115 connects the operation unit 116, which includes a display unit (e.g. a touch panel) and a hardware key, and the control unit 110. The operation unit 116 displays information to the user and detects input from the user. The reading unit I/F 117 connects the reading unit 118, such as a scanner, and the control unit 110. The reading unit 118 reads an image of an original document, and the CPU 111 converts that image into image data such as binary data. The image data generated based on the image read by the reading unit 118 is transmitted to an external apparatus or printed on a printing sheet. The printing unit I/F 119 connects the printing unit 120, such as a printer, and the control unit 110. The CPU 111 transfers the image data (print data) stored in the RAM 113 to the printing unit 120 through the printing unit I/F 119. The printing unit 120 prints an image based on the transferred image data on a printing sheet fed from a feeding cassette.

The wireless communication unit I/F 121 is an I/F for controlling the wireless communication unit 122, and wirelessly connects the control unit 110 and an external wireless device. The FAX unit I/F 123 controls the FAX communication unit 124 to connect to a public line network 80. The FAX unit I/F 123 is an I/F for controlling the FAX communication unit 124, and can, for example, connect to a public line network and control a facsimile communication protocol, by controlling a facsimile communication modem, NCU.

The communication unit I/F 125 connects the control unit 110 and the network 70. Regarding the communication unit I/F 125, the communication unit 126 transmits image data and various kinds of information inside the apparatus to an external apparatus on the network 70, and receives print data from an external apparatus on the network 70 and information on the network 70. As a method of performing transmission and reception via the network 70, transmission and reception can be performed using electronic mail (e-mail) and file transmission can be performed using other protocols (e.g., FTP, SMB, WEBDAV, etc.). Image data and message data can also be transmitted and received on the network 70 by access through HTTP communication from the user terminal 20 and the generative AI server 30. In addition, it is possible to access the MFP 10 via a network from a web browser of the user terminal 20 and perform various settings of the MFP 10 (remote UI function).

### Hardware Configuration of User Terminal

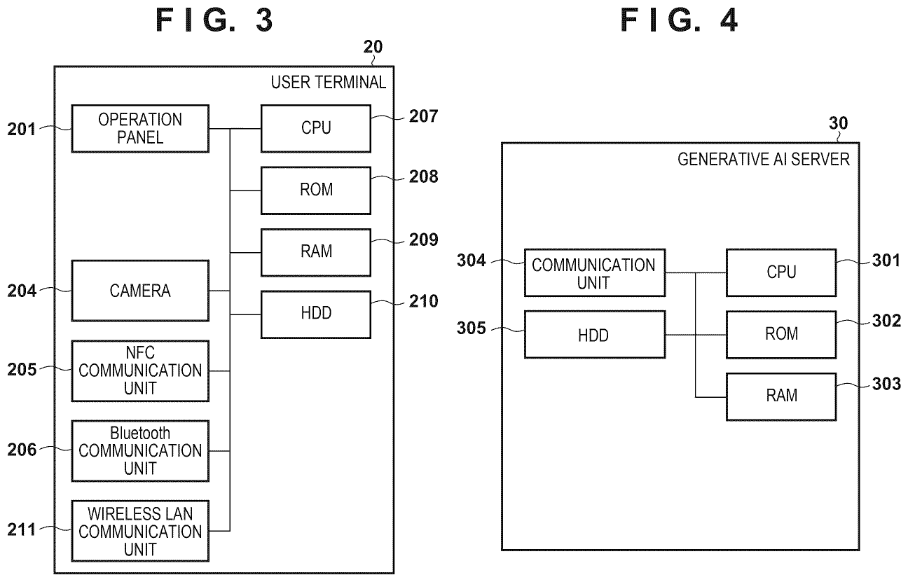

An example of a hardware configuration of the user terminal 20 according to the present embodiment will be described with reference to FIG. 3. The user terminal 20 of the present embodiment is assumed to be an apparatus such as a smart phone or a tablet PC but may be another apparatus so long as it is an information processing apparatus capable of connecting to the network 70 using Wi-Fi communication or the like. The user terminal 20 includes an operation panel 201, a camera 204, an NFC communication unit 205, a Bluetooth® communication unit 206, a CPU 207, a ROM 208, a RAM 209, an HDD 210, and a wireless LAN communication unit 211.

The CPU 207 reads a control program stored in the ROM 208 and executes various processes for controlling the operation of the user terminal 20. The ROM 208 stores the above control program. The RAM 209 is used as a main memory of the CPU 207 and as a temporary storage area such as a work area. The HDD 210 stores various kinds of data such as photos and electronic documents.

The operation panel 201 is provided with a touch panel function capable of detecting the user's touch operation and displays various screens provided by an OS and an electronic mail transmission application. The operation panel 201 is also used to confirm information stored in the generative AI server 30. By inputting a touch operation to the operation panel 201, the user can input a desired operation instruction to the user terminal 20. The user terminal 20 includes a hardware key (not illustrated), and the user can input an operation instruction to the user terminal 20 using the hardware key.

The camera 204 performs imaging according to the user's imaging instruction. A photo captured by the camera 204 is stored in a predetermined region of the HDD 210. In addition, a program capable of analyzing a QR code® can be used to acquire information from a QR code read by the camera 204.

The user terminal 20 can exchange data with various peripheral devices via the NFC communication unit 205, the Bluetooth communication unit 206, and the wireless LAN communication unit 211. The Bluetooth communication unit 206 of the user terminal 20 may support Bluetooth Low Energy (BLE).

### Hardware Configuration of Generative AI Server

An example of a hardware configuration of the generative AI server 30 according to the present embodiment will be described with reference to FIG. 4. The generative AI server 30 includes a CPU 301, a ROM 302, a RAM 303, a communication unit 304, and an HDD 305.

The CPU 301 uses a control program stored in the ROM 302 and a learning model stored in the HDD 305 to execute processing for controlling an operation for generating an appropriate response. The ROM 302 stores the above control program. The RAM 303 is used as a main memory of the CPU 301 and as a temporary storage area such as a work area. The HDD 305 stores various kinds of data such as a learning model and a generative AI application.

Data can be exchanged with various devices such as the user terminal 20, the MFP 10, and the extension application server 40 through the communication unit 304. The communication unit 304 may perform wired communication using Ethernet®, or may perform wireless communication such as Wi-Fi.

### Hardware Configuration of Extension Application Server

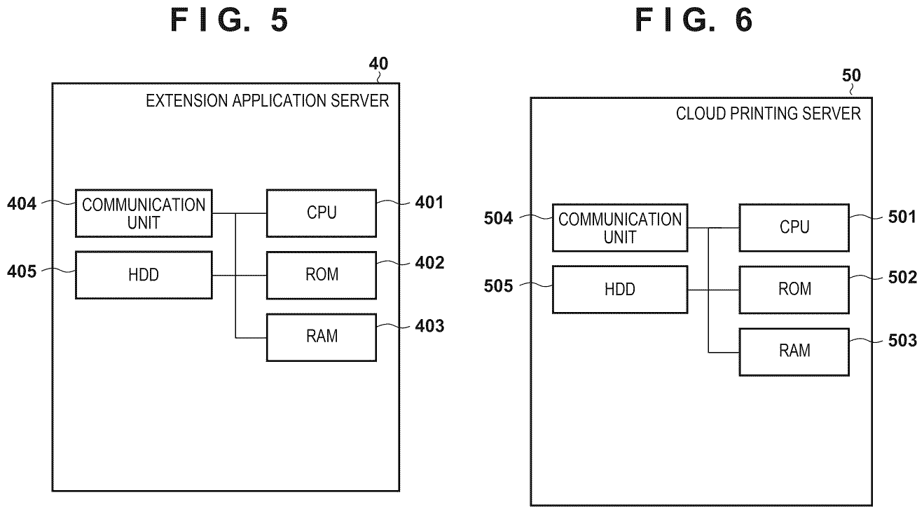

FIG. 5 is a diagram illustrating an example of a hardware configuration of the extension application server 40. The extension application server 40 includes a CPU 401, a ROM 402, a RAM 403, a communication unit 404, and an HDD 405.

The CPU 401 reads a control program stored in the ROM 402 and executes processing according to a message received from the generative AI server 30. The ROM 402 stores the above control program. The RAM 403 is used as a main memory of the CPU 401 and as a temporary storage area such as a work area. The HDD 405 stores content of a message received from the generative AI server 30, a part thereof, and the like. Data can be transmitted and received to and from each device, such as the generative AI server 30, through the communication unit 404.

### Hardware Configuration of Cloud Printing Server

FIG. 6 is a diagram illustrating an example of a hardware configuration of the cloud printing server 50. The cloud printing server 50 includes a CPU 501, a ROM 502, a RAM 503, a communication unit 504, and an HDD 505.

The CPU 501 reads a control program stored in the ROM 502, and can thereby receive a print job from the user terminal 20 and acquire a stored print job. The ROM 502 stores the above control program. The RAM 503 is used as a main memory of the CPU 501 and as a temporary storage area such as a work area. The HDD 505 stores, for example, a print job received from the user terminal 20. Data can be transmitted and received to and from each device, such as the generative AI server 30, through the communication unit 504.

### Print Instruction

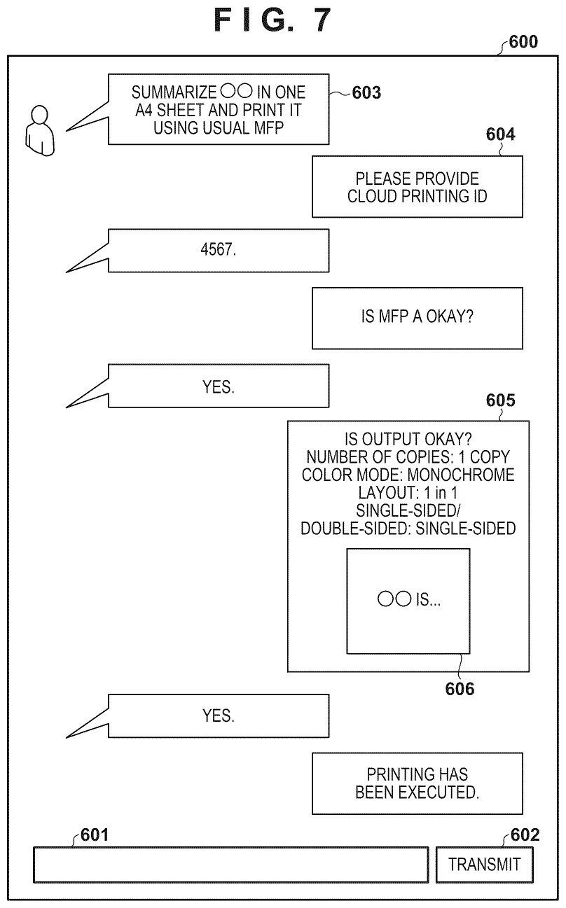

A conversation between the user terminal 20 and the generative AI server 30 for when instructing the generative AI server 30 to perform printing according to the present embodiment will be described with reference to FIG. 7. FIG. 7 illustrates an example of a screen of a conversation for when a printing instruction is performed. A screen 600 is displayed on the operation panel 201 by the generative AI server 30 being accessed from the browser operating on the user terminal 20.

A prompt input field 601 is an input field for the user to input instruction text (prompt) to the generative AI server 30. The user performs input in a natural language text format from the operation panel 201 of the user terminal 20. A speech recognition result of speech input may be treated as text input. A transmission button 602 is a trigger button for transmitting a prompt inputted to the prompt input field 601 to the generative AI server 30.

A print request prompt 603 is an example of a prompt for instructing the generative AI server 30 to perform printing. It needs to include a guideline for text to be generated by the generative AI server 30 and an instruction to print it. A response 604 is a response to the print request prompt 603 for querying the user for a cloud printing ID generated by the generative AI server 30 in cooperation with the extension application server 40. The example of FIG. 7 indicates a state in which a cloud printing ID, “4567”, has been returned as a response from the user.

A cloud printing ID indicates authentication information related to a corresponding user for when using a printer managed on the cloud. Here, an example in which the cloud printing ID is queried for has been described, but it is not intended to limit the present invention. It need only be information identifying the user and managed by the cloud printing server 50. That is, it may be any information so long as it is information that is useful for the user to specify an MFP to be used through the cloud printing server 50. Information such as the cloud printing ID may be assigned for each user or to a group.

The cloud printing server 50 manages, for example, permissions related to a scope of receiving cloud services, a use history, and the like for each cloud printing ID. Thereafter, interactive interactions between the user and the generative AI server 30 are arranged in chronological order in combinations of a prompt and a response.

The generative AI server 30 analyzes the content of a message from the user terminal 20 and returns an appropriate response. If the content of the message is such that a response can be created only by the generative AI server 30, a response is created and displayed in the response 604. If it is determined from the content of the message that the message is to be processed by the extension application server 40, a processing request is executed to the extension application server 40. In addition, a response to the user terminal 20 is created from the content of a response from the extension application server 40.

For example, if a message from the user terminal 20 contains a keyword “print”, an extension application server related to printing is selected and a processing request is executed. By doing so, print processing in the MFP 10, which cannot be realized by the generative AI server 30 alone, becomes possible. The generative AI server 30 and the extension application server 40 may be provided in an integrated manner, in which case processing of the extension application server 40 may be configured to operate as a single module.

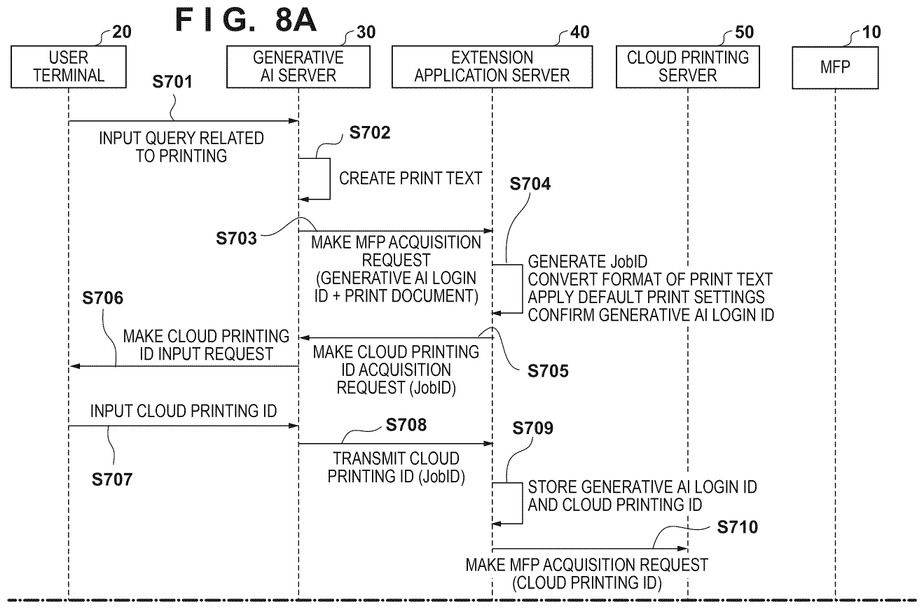

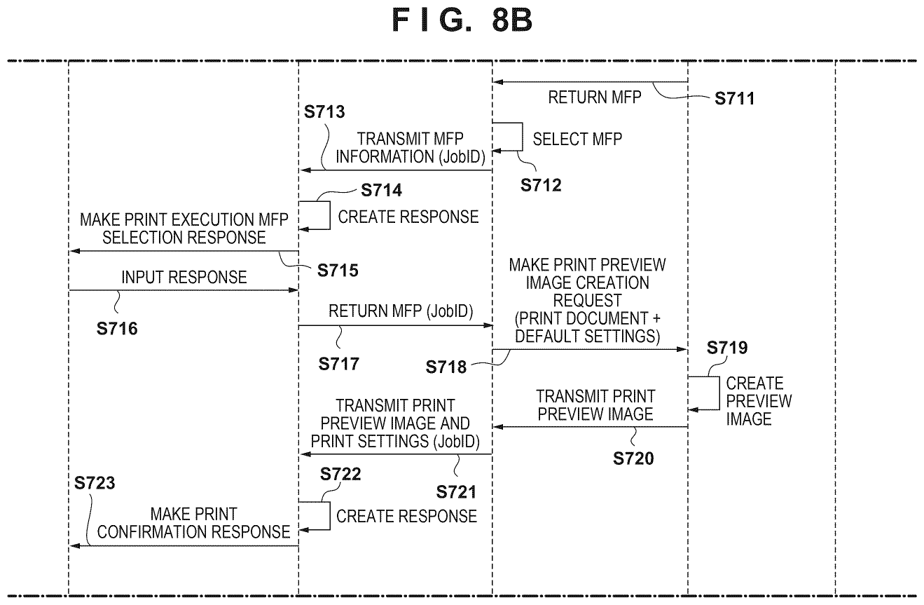

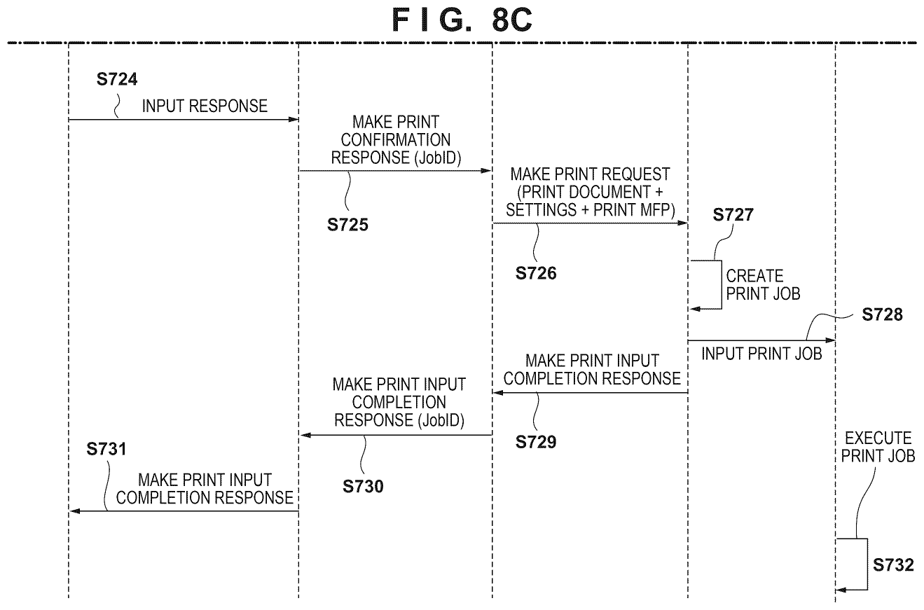

In the present embodiment, an example from when a message to perform printing is inputted to the prompt input field 601 in the user terminal 20 and interaction with the generative AI server 30 is performed until when printing is executed in the MFP 10 is described. The processing will be described later in detail with reference to FIGS. 8A-8C. A response 605 indicates a print request response that includes settings for printing to be performed and a preview image 606. The user confirms print settings and the preview image 606 and, if they wish to change a setting, can do so by giving an instruction in the prompt input field 601.

### Sequence

A sequence between respective apparatuses in the printing system from when the user instructs the generative AI server 30 to perform printing until when a print job is actually inputted to the MFP 10 according to the present embodiment will be described with reference to FIGS. 8A-8C. In the sequence to be described below, in a case where the generative AI server 30 and the extension application server 40 are provided in an integrated manner, control of the two apparatuses will be integrated.

In step S701, the user terminal 20 transmits the content of the print request prompt 603 to the generative AI server 30 according to a user operation through the browser. Then, the generative AI server 30, in step S702, generates text (text data) to be printed and, in step S703, transmits an MFP acquisition request to the extension application server 40. At this time, the generative AI server 30 transmits the text data generated in step S702 together with a login ID for the generative AI server 30.

Then, in step S704, the extension application server 40 generates and stores a JobID. The JobID is unique identification information for managing various kinds of data to be handled in the future in association with each other. In addition, the extension application server 40 converts the text data received from the generative AI server 30 to a format (e.g., PDF) that can be accepted by the cloud printing server 50. If the cloud printing server 50 can accept text data, this processing may be skipped. Then, the extension application server 40 stores default print settings as the current print settings. Then, the extension application server 40 confirms whether a cloud printing ID stored in association with the login ID for the generative AI server 30 is stored. If it is stored, the processing from steps S705 to S708 may be skipped.

In step S705, the extension application server 40 performs a cloud printing ID acquisition request to the generative AI server 30. To clarify which job the interaction is for between the generative AI server 30 and the extension application server 40 thereafter, messages are exchanged, including the JobID. In step S706, the generative AI server 30 returns a cloud printing ID input request to the user terminal 20 as a response to step S701.

In step S707, the user terminal 20 accepts input of a cloud printing ID (“4567” in the example of FIG. 7) to the prompt input field 601 according to the user operation through the browser and transmits the cloud printing ID to the generative AI server 30. In step S708, the generative AI server 30 transmits the cloud printing ID received in step S707 to the extension application server 40. In step S709, the extension application server 40 stores the login ID for the generative AI server 30 received in step S703 and the cloud printing ID received in step S708 in association with each other. In step S710, the extension application server 40 transmits an MFP acquisition request to the cloud printing server 50 together with the cloud printing ID.

In step S711, the cloud printing server 50 transmits, to the extension application server 40, information of an MFP for which there is a history of use of the cloud printing ID received in step S710. Here, the MFP information is apparatus information related to an available image forming apparatus including the name, the use history, and the like of the MFP. It is not intended to limit the present invention, and the MFP information need only include information for identifying a predetermined MFP. In addition, the MFP information transmitted here includes information corresponding to one or more MFPs. That is, in step S711, the cloud printing server 50 operates to provide apparatus information (MFP information) associated with authentication information (cloud printing ID) related to the user.

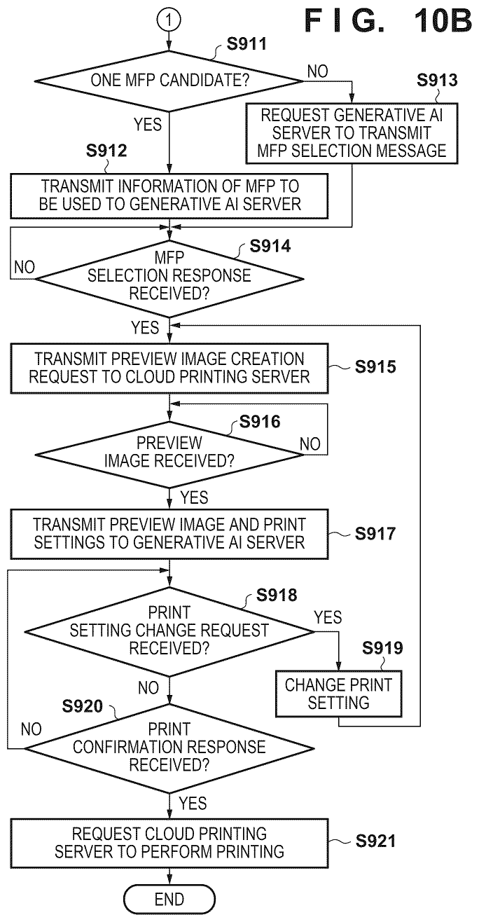

In step S712, the extension application server 40 selects an MFP to perform printing from the MFP information received in step S711. The processing for when there are a plurality of selection candidates will be described later with reference to FIGS. 10A-10B. In step S713, the extension application server 40 transmits the MFP information selected in step S712 to the generative AI server 30.

In step S714, the generative AI server 30 creates a response message from the MFP information received in step S713. In step S715, the generative AI server 30 returns, to the user terminal 20, a message prompting a response to selection of an MFP to execute printing created in step S714 as a response to step S707. This message corresponds to “Is MFP A okay?” in the example of FIG. 7, and queries the user if it is okay to execute printing on “MFP A”, which is the name of the selected MFP.

In step S716, the user terminal 20 accepts input that the MFP of step S715 is okay in the prompt input field 601 according to the user's operation through the browser and transmits the input to the generative AI server 30. In step S717, the generative AI server 30 transmits to the extension application server 40 that the response of step S716 indicates that it is okay. In step S718, the extension application server 40 transmits a print preview image creation request to the cloud printing server 50. At this time, the extension application server 40 transmits the converted data generated in step S704 and the current print settings.

In step S719, the cloud printing server 50 creates the preview image 606, which is the image of an output. In step S720, the cloud printing server 50 transmits the preview image 606 created in step S719 to the extension application server 40. In step S721, the extension application server 40 transmits the preview image received in step S720 and the print settings to the generative AI server 30. In step S722, the generative AI server 30 creates a response message from the preview image and the print settings received in step S721. In step S723, the generative AI server 30 returns, to the user terminal 20, a response (message) 605 confirming whether the printed matter created in step S722 is okay as a response to step S716 as information to be presented to the user. As described above, the response 605 includes the preview image 606 created in step S719. The user terminal 20 presents the information to the user via the browser according to the received information.

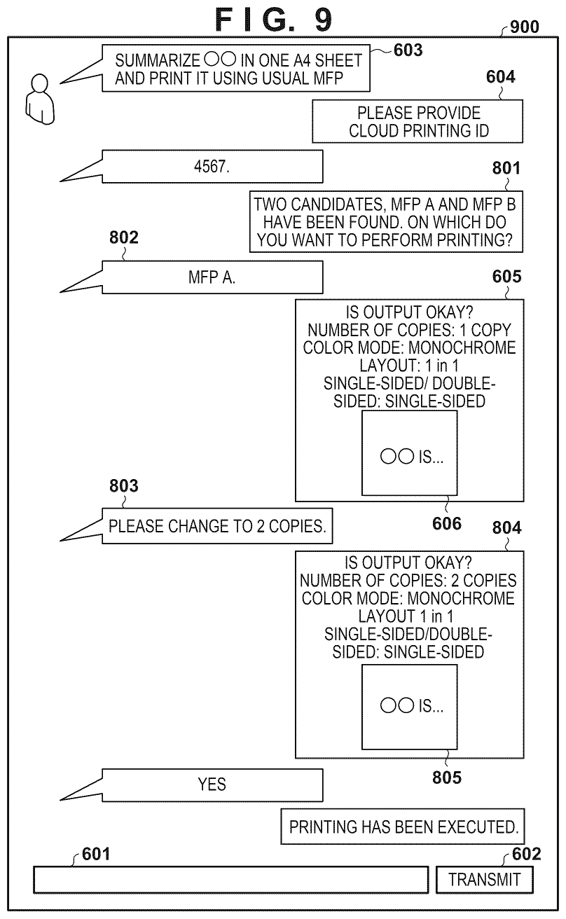

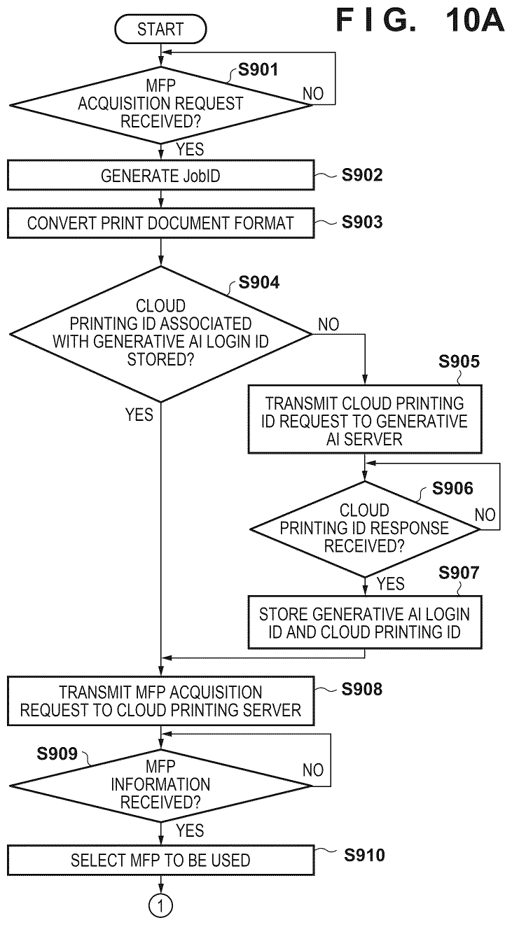

In step S724, the user terminal 20 accepts input that the content of step S723 is okay in the prompt input field 601 according to the user's operation through the browser and transmits the input to the generative AI server 30. The processing for changing a print setting here will be described later with reference to FIGS. 9 and 10. In step S725, the generative AI server 30 transmits to the extension application server 40 that the response of step S724 indicates that it is okay. In step S726, the extension application server 40 performs a print request to the cloud printing server 50. At this time, the extension application server 40 transmits the converted data generated in step S704, the current print settings, and the information of the MFP to execute printing to the cloud printing server 50.

In step S727, the cloud printing server 50 creates a print job for the MFP to execute printing from the print settings and the print document received in step S726. In step S728, the cloud printing server 50 inputs the print job created in step S727 to the MFP to execute printing received in step S726. The input of the print job may take a configuration in which the cloud printing server 50 transmits print data to the target MFP and printing is performed in that MFP, or the MFP is notified that a print job has been inputted and the MFP acquires print data from the cloud printing server 50.

In step S729, the cloud printing server 50 transmits to the extension application server 40 that print job input to the MFP has been completed. In step S730, the extension application server 40 transmits to the generative AI server 30 that print job input to the MFP has been completed. In step S731, the generative AI server 30 returns to the user terminal 20 that print job input to the MFP has been completed as a response to step S724. In the user terminal 20, “Printing has been executed.” is displayed as a response.

In step S732, the MFP 10 prints the print job received in step S728. In the present embodiment, the MFP automatically executes the job based on reception of the print job, but may execute the print job based on acceptance of an execution instruction by the user after reception of the print job.

### Changing Print Setting

An example of a conversation between the user and the generative AI server 30 for when instructing the generative AI server 30 to perform printing when changing a print setting according to the present embodiment will be described with reference to FIG. 9. Here, the description of parts similar to those of FIG. 7 will be omitted. A screen 900 is displayed on the operation panel 201 by the generative AI server 30 being accessed from the browser operating on the user terminal 20.

An MFP selection response 801 is a response for when a plurality of candidates are found as a result of the generative AI server 30 searching for an MFP in cooperation with the extension application server 40 in response to “the usual MFP” in the prompt 603. If a plurality of candidates are found, a response that selection be made will be generated to the user terminal 20. The response 801 indicates a response for when two candidates “MFP A” and “MFP B” are found. An MFP selection prompt 802 is a prompt for the user to select an MFP.

A print setting change prompt 803 is an example of a prompt for instructing the generative AI server 30 to change a setting when the user wishes to change a print setting confirmed in the print request response 605. In the present embodiment, it is instructed to change the number of copies to two copies, but it may be instructed to change another setting (e.g., change the sheet size, set the layout to 2in1, etc.). In addition, an instruction for changing a plurality of settings may be included.

A print setting change response 804 is a response to the print setting change prompt 803 generated by the generative AI server 30 in cooperation with the extension application server 40. The basic content does not change from that of the print request response 605, but the instructed change content are reflected in the print settings, and the print job is updated. In addition, when settings such as the color mode or the layout that change the preview image are changed, the preview image 606 is also replaced.

### Processing Procedure of Extension Application Server

A processing procedure of the extension application server 40 according to the present embodiment will be described with reference to FIGS. 10A-10B. The processing to be described below is realized, for example, by the CPU 401 reading a program stored in the ROM 402 to the RAM 403 and executing the program. Further, the following processing is realized by a plug-in that extends the functions of the generative AI server 30 being executed. In the present embodiment, the plug-in (program) will be described as being managed and executed by the extension application server 40, but it is not intended to limit the present invention. For example, the plug-in managed by the extension application server 40 may be installed in the generative AI server 30 and executed in the generative AI server 30. Alternatively, the generative AI server 30 and the extension application server 40 may be provided in an integrated manner, in which case the integrated server controls management, installation, and execution of the plug-in.

In step S901, the CPU 401 determines whether an MFP acquisition request has been received from the generative AI server 30. Here, the MFP acquisition request includes, for example, text data and login ID data for the generative AI server 30. If the MFP acquisition request has been received, the processing proceeds to step S902; otherwise, the determination of step S901 is repeated.

In step S902, the CPU 401 generates a JobID. In step S903, the CPU 401 converts the text data received in step S901 into a print document data format that can be accepted by the cloud printing server 50. In step S904, the CPU 401 determines whether a cloud printing ID associated with the login ID for the generative AI server 30 received in step S901 is stored in the HDD 405. If it is stored, the processing proceeds to step S908, and if it is not stored, the processing proceeds to step S905.

In step S905, the CPU 401 transmits a cloud printing ID request to the generative AI server 30. In step S906, the CPU 401 determines whether a cloud printing ID has been returned from the generative AI server 30. If it has been returned, the processing proceeds to step S907; otherwise, the determination of step S907 is repeated. In step S907, the CPU 401 stores the cloud printing ID and the login ID for the generative AI server 30 received from the generative AI server 30 in association with each other in the HDD 405 and proceeds to step S908.

In step S908, the CPU 401 transmits an MFP acquisition request to the cloud printing server 50. The MFP acquisition request includes at least the cloud printing ID. In step S909, the CPU 401 determines whether MFP information (apparatus information related to an available image forming apparatus) has been returned from the cloud printing server 50. If it has been returned, the processing proceeds to step S910; otherwise, the determination of step S909 is repeated.

In step S910, the CPU 401 selects an MFP to be transmitted to the generative AI server 30. If there are a plurality of pieces of MFP information, it is determined on which MFP to perform printing from the use history. For example, one with the highest use count or one used most recently is selected. In step S911, the CPU 401 determines whether there is one MFP candidate. For example, in cases such as that where there are a plurality of MFPs with the same count for the use history, it is determined that there are a plurality of candidates. If it is determined that there is one, the processing proceeds to step S912, and if it is determined that there are a plurality, the processing proceeds to step S913.

In step S912, the CPU 401 transmits MFP information corresponding to an MFP to be used to the generative AI server 30 and proceeds to step S914. Meanwhile, in step S913, the CPU 401 makes a request to the generative AI server 30 that it transmit the MFP selection response 801 and proceeds to step S914. In step S914, the CPU 401 determines whether an MFP selection response has been received from the generative AI server 30. If it has been received, the processing proceeds to step S915; otherwise, the determination of step S914 is repeated.

In step S915, the CPU 401 transmits a preview image creation request (including a print document and print settings) to the cloud printing server 50. In step S916, the CPU 401 determines whether a preview image has been received from the cloud printing server 50. If it is determined that it has been received, the processing proceeds to step S917; otherwise, the determination of step S916 is repeated.

In step S917, the CPU 401 transmits the print settings and the preview image received in step S916 to the generative AI server 30. In step S918, the CPU 401 determines whether a setting has been changed according to the print setting change prompt 803 from the generative AI server 30. If it is determined that a setting has been changed, the processing proceeds to step S919, and if it is determined that the settings have not been changed, the processing proceeds to step S920.

In step S919, the CPU 401 changes the setting according to the content of the setting change request received in step S918, stores it in the HDD 405, and returns the processing to step S915. Meanwhile, in step S920, the CPU 401 determines whether a response indicating that print settings are okay has been received from the generative AI server 30. If it is determined that they are okay, the processing proceeds to step S921; otherwise, the determination of step S918 is repeated. In step S921, the CPU 401 transmits a print request (including a print document, print settings, and MFP information) to the cloud printing server 50 and terminates the processing of the flowchart.

As described above, the computer program (plug-in) according to the present embodiment is a computer program that extends the functions of the generative AI service. Upon receiving a print request through the generative AI service, the computer program causes a computer of the information processing apparatus to function so as to acquire authentication information related to the user. The computer program causes the above computer to function so as to acquire apparatus information related to an available image forming apparatus from the printing server using the acquired authentication information related to the user, and specify the image forming apparatus to execute printing based on the apparatus information. According to the present embodiment, it is possible to suitably print output from generative AI on an image forming apparatus. In addition, the user can perform printing on an image forming apparatus by simply making input to the generative AI service.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™M), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-223264, filed Dec. 28, 2023 which is hereby incorporated by reference herein in its entirety.

What is claimed is:

1. A non-transitory computer-readable storage medium storing a computer program for extending a function of a generative AI service, wherein the computer program is for causing a computer of an information processing apparatus to function so as to:
upon accepting a print request via the generative AI service, acquire authentication information related to a user;
using the acquired authentication information related to the user, acquire apparatus information related to an available image forming apparatus from a printing server; and
based on the apparatus information, specify an image forming apparatus to execute printing.

2. The storage medium according to claim 1, wherein
the computer program is further for causing the computer of the information processing apparatus to function so as to:
query the user based on the apparatus information via the generative AI service, and specify an image forming apparatus to execute printing.

3. The storage medium according to claim 2, wherein
the computer program is further for causing the computer of the information processing apparatus to function so as to:
in a case where the apparatus information includes information related to a plurality of image forming apparatuses, query the user for selection of an image forming apparatus to execute printing from among the plurality of image forming apparatuses via the generative AI service.

4. The storage medium according to claim 1, wherein
the computer program is further for causing the computer of the information processing apparatus to function so as to:
generate a print job based on the print request; and
present, to the user, information related to the generated print job via the generative AI service.

5. The storage medium according to claim 4, wherein
the computer program is further for causing the computer of the information processing apparatus to function so as to:
acquire, from the printing server, a preview image for when the print job is to be executed; and
present, as information related to the print job, a print setting for when executing the print job and the preview image.

6. The storage medium according to claim 5, wherein
the computer program is further for causing the computer of the information processing apparatus to function so as to:
upon accepting a request to change a setting of the print job presented to the user via the generative AI service, update the print job according to change content.

7. The storage medium according to claim 4, wherein
the computer program is further for causing the computer of the information processing apparatus to function so as to:
assign unique identification information in a case where generating the print job.

8. The storage medium according to claim 7, wherein
the computer program is further for causing the computer of the information processing apparatus to function so as to:
convert text data included in the print request accepted via the generative Al service into a format that can be accepted by the printing server, and generate print data.

9. The storage medium according to claim 8, wherein
the computer program is further for causing the computer of the information processing apparatus to function so as to:
set a preset print setting for the generated print job.

10. The storage medium according to claim 8, wherein
the computer program is further for causing the computer of the information processing apparatus to function so as to:
set a print setting for the generated print job based on the text data included in the print request.

11. The storage medium according to claim 4, wherein
upon acceptance of a print instruction by the user via the generative AI service for the information related to the print job presented to the user, the print job is inputted to an image forming apparatus from the printing server and the print job is caused to be executed.

12. The storage medium according to claim 4, wherein
the computer program is implemented in the information processing apparatus as a plug-in of the generative AI service.

13. A print control method comprising:
upon accepting a print request via a generative AI service provided by an information processing apparatus, acquiring authentication information related to a user;
using the acquired authentication information related to the user, acquiring apparatus information related to an available image forming apparatus from a printing server; and
based on the apparatus information, specifying an image forming apparatus to execute printing.

14. A printing system including an information processing apparatus providing a generative AI service to a user terminal, a printing server, and an image forming apparatus,
the information processing apparatus comprising:
one or more first memory devices that store a computer program for extending a function of the generative AI service; and
one or more first processors that execute the computer program to:
upon accepting a print request via the generative AI service, acquire authentication information related to a user;
using the acquired authentication information related to the user, acquire apparatus information related to an available image forming apparatus from a printing server; and
based on the apparatus information, specify an image forming apparatus to execute printing, and
the printing server comprising:
one or more second memory devices that store a set of instructions; and
one or more second processors that execute the set of instructions to:
provide the apparatus information associated with the authentication information related to the user; and
upon being instructed to execute printing via the generative AI service, input a print job based on the print request to the specified image forming apparatus.

15. The printing system according to claim 14, wherein
the printing server is a cloud printing server.
